(19) United States
(12) Patent Application Publication
(10) Pub. No.: US 2015/0001263 A1
(43) Pub. Date: Jan. 1, 2015

(54) FASTENING ASSEMBLY AND ELECTRONIC DEVICE THEREFORE

(71) Applicant: HON HAI PRECISION INDUSTRY CO., LTD., New Taipei (TW)

(72) Inventor: WEI-SHIH CHEN, New Taipei (TW)

(73) Assignee: HON HAI PRECISION INDUSTRY CO., LTD., New Taipei (TW)

(21) Appl. No.: 14/252,161

(22) Filed: Apr. 14, 2014

(30) Foreign Application Priority Data
Jun. 28, 2013 (TW) 102123121

(51) Int. Cl. A45F 5/00; A44B 17/00; F16B 19/00

(52) U.S. Cl. CPC A45F 5/00; F16B 19/00; A44B 17/00
USPC 224/257; 24/458

(57) ABSTRACT

A fastening assembly for securing a shoulder belt to a portable computer includes a latching member, a fastening member, a locking cap, and a resilient ring. The resilient ring is located between the latching member and the locking cap. The fastening member extends through the latching member from a first side of the latching member. The locking cap is located on a second side of the latching member and engaged with the fastening member. The fastening member with the locking cap is moveable relative to the latching member to compress the resilient ring in order to secure the latching member to the portable computer. The resilient ring is restored to release the latching member from the portable computer.

### CROSS-REFERENCE TO RELATED APPLICATIONS

This application claims priority to Taiwan Patent Application No. 102123121 filed on Jun. 28, 2013 in the Taiwan Intellectual Property Office, the contents of which are hereby incorporated by reference.

### FIELD

The present disclosure relates to electronic devices, and more particularly to an electronic device with a fastening assembly.

### BACKGROUND

Portable computers are widely used. However, it is inconvenient to carry the portable computer without an extra bag. Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. In the drawings, like reference numerals designate corresponding parts throughout the several views.

FIG. 1 is an exploded, isometric view of an embodiment of an electronic device comprising two fastening assemblies, a base, a shoulder belt, and a top cover.

FIG. 2 is an enlarged view of a circled portion II of FIG. 1.

FIG. 3 is a partially assembled view of one of the two fastening assemblies and the base of FIG. 1.

FIG. 4 is an assembled view of the one of the two fastening assemblies and the base of FIG. 1.

FIG. 5 is similar to FIG. 4, but shows the fastening assembly in another state of use.

FIG. 6 is an assembled view of the electronic device of FIG. 1.

FIG. 7 is a cross-sectional view taken along line VII-VII of FIG. 6.

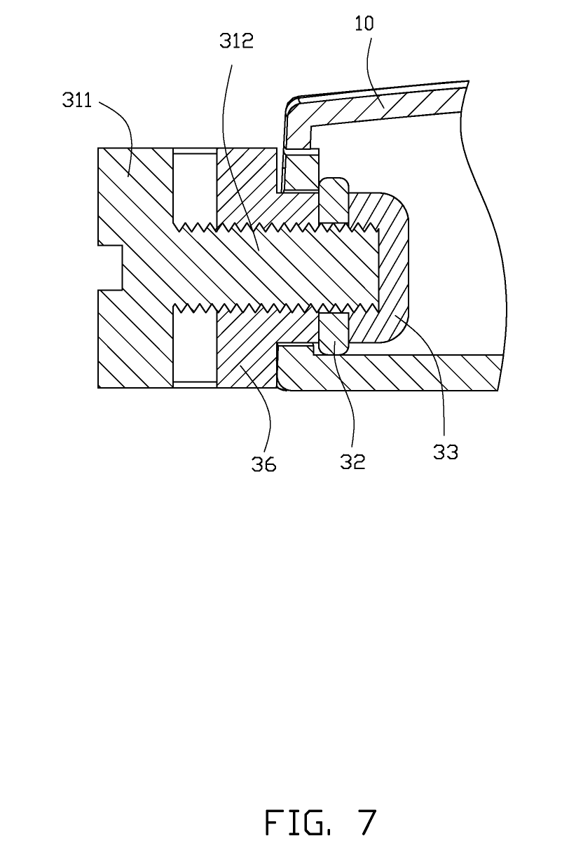

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

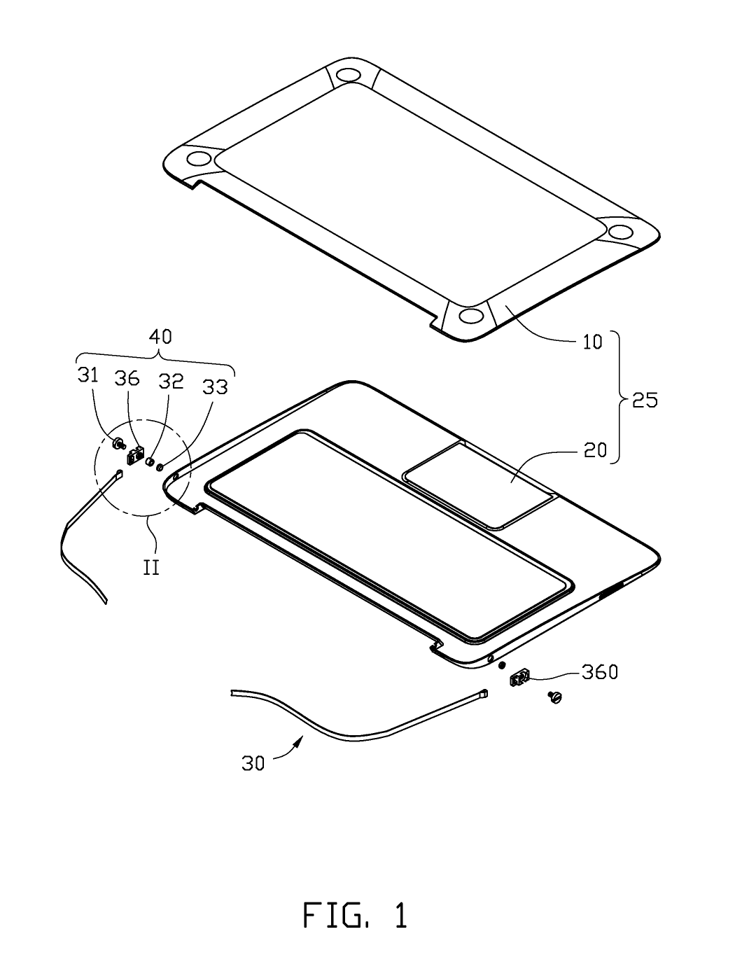

FIG. 1 illustrates an embodiment of an electronic device. The electronic device includes a portable computer 25, a shoulder belt 30, and two fastening assemblies 40. The fastening assemblies 40 are configured to secure the shoulder belt 30 to the portable computer 25. In one embodiment, the portable computer 25 is a notebook.

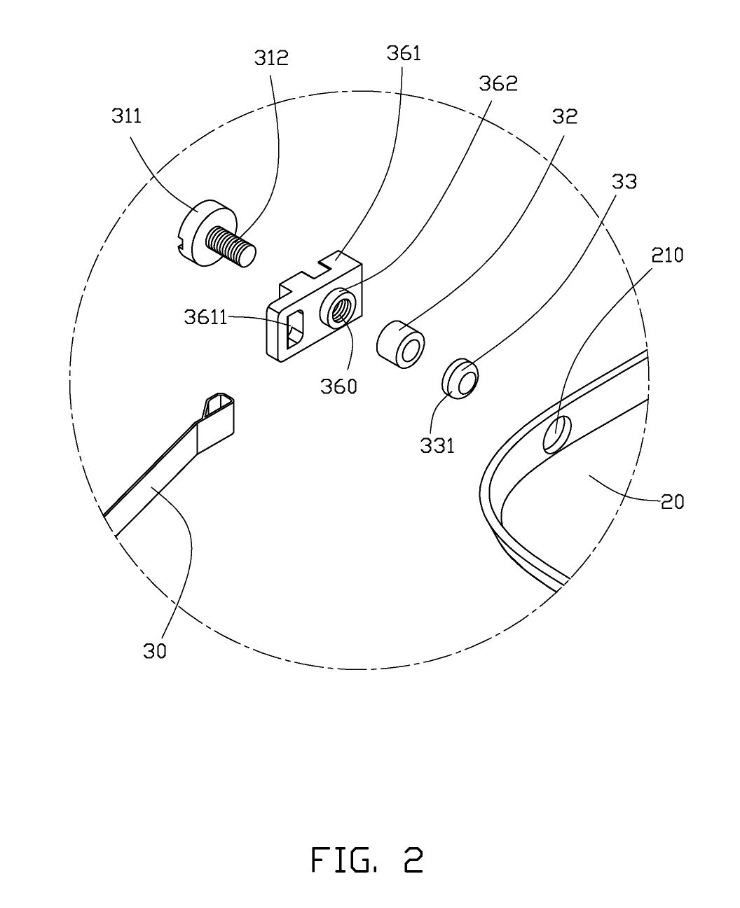

The portable computer 25 includes a base 20 and a top cover 10 pivotably secured to the base 20. The base 20 defines two installation holes 210 (shown in FIG. 2) corresponding to the two fastening assemblies 40 one-to-one.

FIGS. 1 and 2 show, each of the two fastening assemblies 40 includes a fastening member 31, a resilient ring 32, a locking cap 33, and a latching member 36. The fastening member 31 includes a screw cap 311 and a screw pole 312 extending from the screw cap 311. A diameter of a cross-section of the screw cap 311 is greater than a diameter of a cross-section of the screw pole 312. The screw pole 312 defines a plurality of outer threads (not labeled). The locking cap 33 forms a tapered guiding surface 331.

In FIG. 1, the latching member 36 includes a latching block 361 and a positioning post 362. The positioning post 362 extends outwards from the latching block 361. The latching block 361 defines a through hole 360 extending through the positioning post 362. The through hole 360 defines a central axis. The positioning post 362 has an external diameter slightly smaller than an inner diameter of the corresponding installation hole 210. A plurality of inner threads (not labeled) is formed on an inner wall of the through hole 360. The plurality of inner threads corresponds to the plurality of outer threads. A diameter of the through hole 360 is slightly greater than the diameter of the cross-section of the screw pole 312. The latching block 361 defines a latching hole 3611 corresponding to the shoulder belt 30.

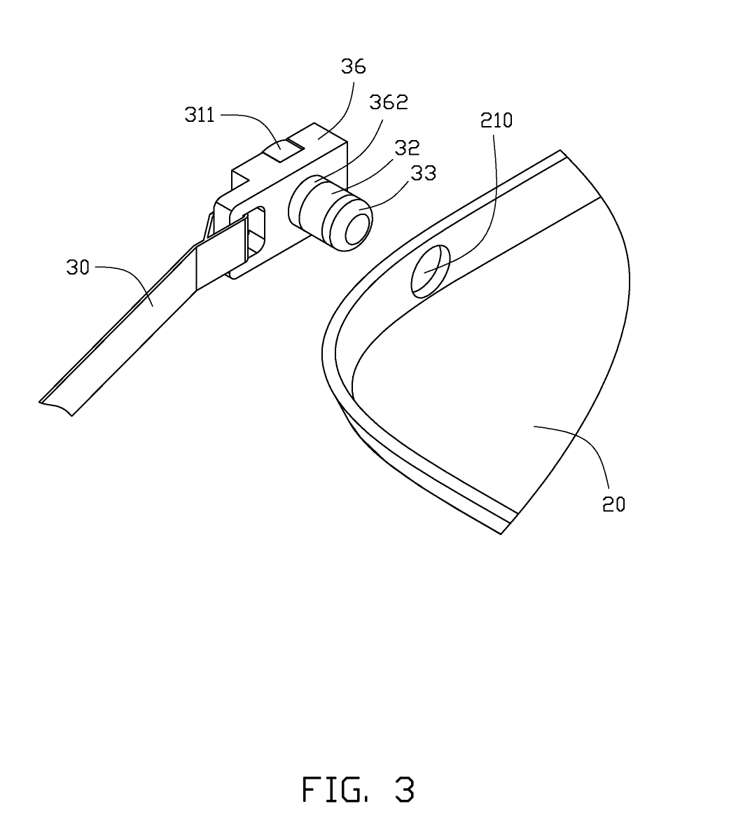

FIG. 3 illustrates an assembled view of one of the two fastening assemblies 40. The screw pole 312 of the fastening member 31 is screwed through the through hole 360 of the latching block 361, until the screw cap 311 abuts a first side of the latching block 361, and the screw pole 312 partially extends out of the positioning post 362. The resilient ring 32 is sleeved on the part of the screw pole 312 extending out of the positioning post 362 and abuts the positioning post 362 at a second side of the latching block 361. The locking cap 33 is engaged with a distal end of the screw pole 312 and abuts the resilient ring 32. The other fastening assembly 40 is assembled the same way.

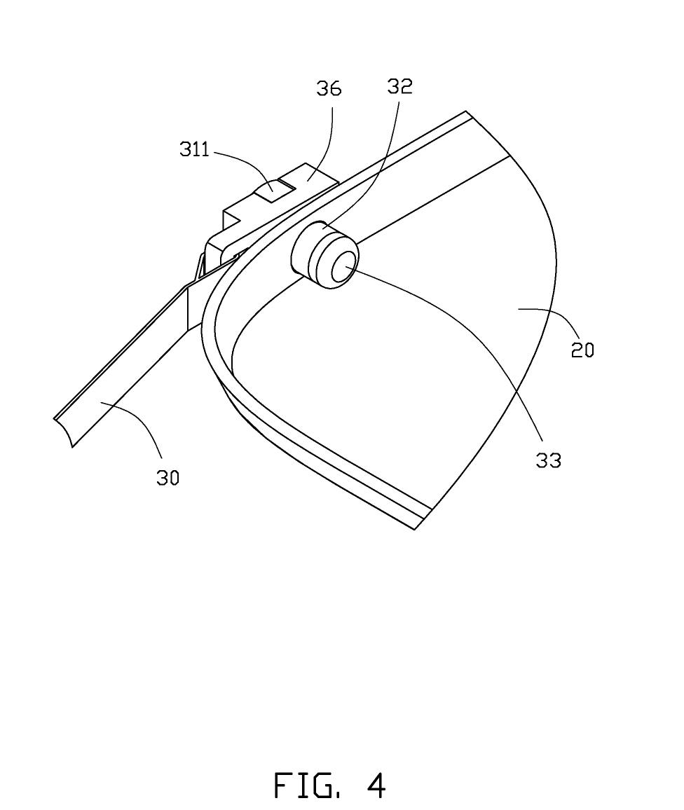

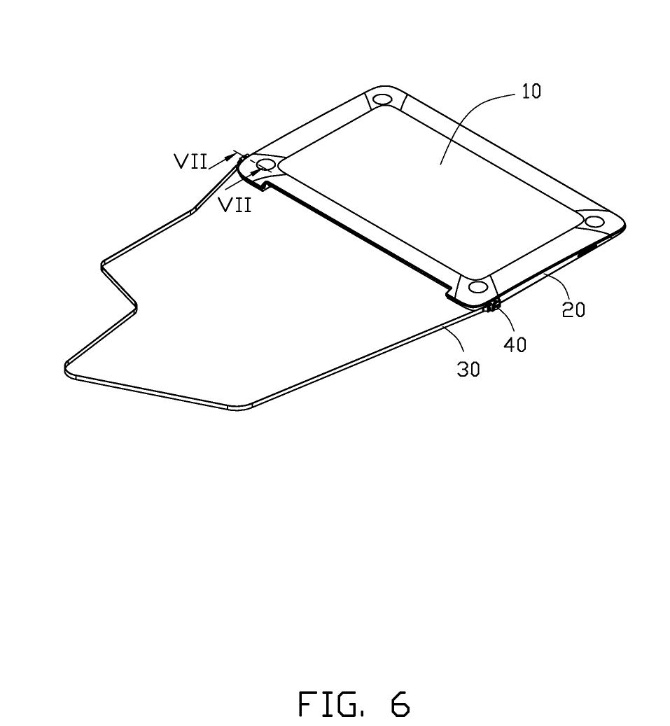

FIGS. 4-6 illustrate an assembled view of one of the two fastening assemblies 40 and the base 20. The resilient ring 32 and the locking cap 33 are extended through the corresponding installation hole 210, until the positioning post 362 is received in the installation hole 210. Thus, the resilient ring 32 and the locking cap 33 are received in the base 20, and the latching block 361 abuts an outer surface of the base 20.

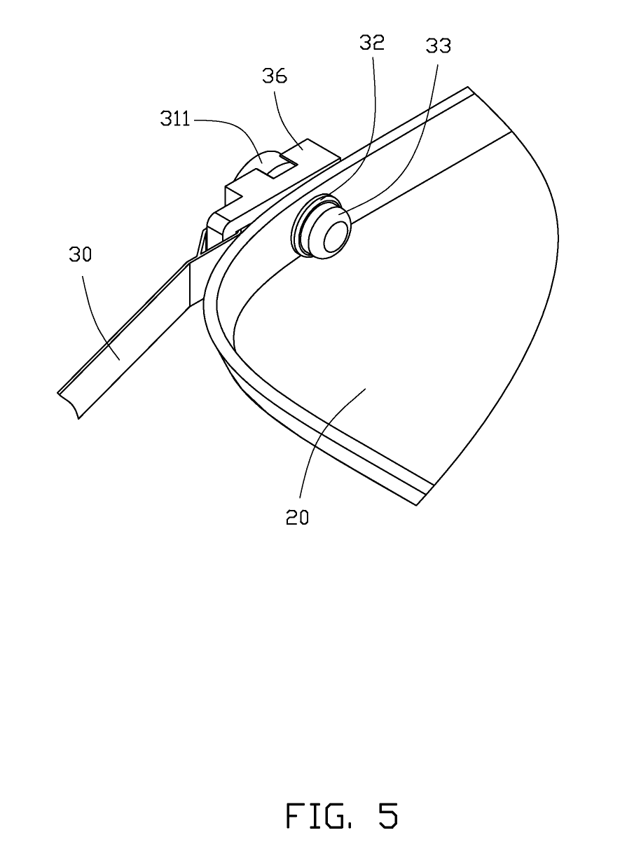

The fastening member 31 is rotatable relative to the latching member 36 to move the locking cap 33 along a first direction that is parallel to the center axis toward the latching member 36, thereby compressing the resilient ring 32 (shown in FIG. 5). An external diameter of the compressed resilient ring 32 is greater than the inner diameter of the through hole 210. The latching block 361 resists the outer surface of the base 20, and the resilient ring 32 resists an inner surface of the base 20. Therefore, the latching member 36 is secured to the base 20. Two opposite ends of the shoulder belt 30 are hung in the corresponding latching holes 3611. Thus, a user can carry the portable computer 25 by the shoulder belt 30.

The fastening member 31 is rotatable relative to the latching member 36 to move the locking cap 33 along a third direction opposite to the first direction and away from the latching member 36, thereby restoring the resilient ring 32 (shown in FIG. 4). External diameters of the restored resilient ring 32 and the locking cap 33 are substantially equal to the external diameter of the positioning post 362. Therefore, the latching member 36 can be removed from the base 20.

It is to be understood, however, that even though numerous characteristics and advantages have been set forth in the foregoing description of embodiments, together with details of the structures and functions of the embodiments, the disclosure is illustrative only and changes may be made in detail, including in the matters of shape, size, and arrangement of parts within the principles of the disclosure. The embodiments discussed are illustrative only, and are not intended to limit the scope of the following claims.

What is claimed is:

1. A fastening assembly for securing a shoulder belt to a portable computer, comprising:
a latching member connected to the shoulder belt;
a fastening member engaged with and extending through the latching member from a first side of the latching member;
a locking cap located on a second side of the latching member, and the locking cap engaged with the fastening member; and
a resilient ring located between the latching member and the locking cap;
wherein the locking cap is movable along a first direction towards the latching member driven by the fastening member, and the resilient ring is configured to resiliently protrude along a second direction that is perpendicular to the first direction, to lock the latching member to the portable computer.

2. The fastening assembly of claim 1, wherein the latching member defines a through hole, the fastening member comprises a screw pole, the screw pole is received in the through hole, the resilient ring surrounds the screw pole, and the locking cap is engaged with the screw pole.

3. The fastening assembly of claim 2, wherein the through hole defines a center axis, and the first direction and the second direction are parallel to the center axis.

4. The fastening assembly of claim 2, wherein the latching member comprises a latching block and a positioning post located on the latching block, and the through hole is defined in the latching block and extends to the positioning post.

5. The fastening assembly of claim 4, wherein the positioning post is configured to be received in an installation hole define in the portable computer.

6. The fastening assembly of claim 4, wherein the latching block defines a latching hole, and the shoulder belt is configured to be engaged in the latching hole.

7. An electronic device, comprising:
a portable computer comprising a base;
a shoulder belt; and
a fastening assembly, the fastening assembly comprising:
a latching member received in the base and connected to the shoulder belt;
a fastening member being rotatably engaged in the through hole;
a locking cap engaged with the fastening member; and
a resilient ring surrounding the fastening member;
wherein the locking cap is movable relative to the latching between a first position and a second position driven by the fastening member, when the locking cap is located in the first position, the locking cap compresses the resilient ring, and the resilient ring is resiliently deformable to locate between the base and the locking cap; when the locking cap is located in the second position, the locking cap abuts the resilient ring, and the resilient ring is shrinkable to locate between the latching member and the locking cap.

8. The electronic device of claim 7, wherein the base defines an installation hole, when the locking cap is located in the first position, an external diameter of the resilient ring is greater than an inner diameter of installation hole; when the locking cap is located in the second position, the external diameter of the resilient ring is slightly smaller than the inner diameter of installation hole.

9. The electronic device of claim 8, wherein the latching member comprises a positioning post, and the positioning post is engaged in the installation hole.

10. The electronic device of claim 9, wherein an external diameter of positioning post is slightly smaller than an inner diameter of the installation hole.

11. The electronic device of claim 9, wherein the latching member further comprises a latching block connected to the positioning post; when the locking cap is located in the first position, the latching block abuts an outer side of the base, and the resilient ring abuts an inner side of the base; when the locking cap is located in the second position, the resilient ring is disengaged from the base.

12. The electronic device of claim 11, wherein the latching block defines a latching hole, and the shoulder belt is engaged in the latching hole.

13. The fastening assembly of claim 11, wherein the latching member defines a through hole extending to the positioning post, the fastening member comprises a screw pole, and the screw pole is engaged in the through hole, the resilient ring surrounds the screw pole, and the locking cap is engaged with the screw pole.

14. The electronic device of claim 13, wherein the screw pole is rotatable relative to the latching member to move the locking cap along a first direction to the first position, and along a second direction opposite to the first direction to the second position.

15. The electronic device of claim 14, wherein the through hole has a center axis, and the first direction and the second direction are parallel to the center axis.
